(19) United States
(12) Patent Application Publication
(10) Pub. No.: US 2009/0324194 A1
(43) Pub. Date: Dec. 31, 2009

(54) RECORDING/REPRODUCING APPARATUS AND CONTROL METHOD OF RECORDING/REPRODUCING APPARATUS

(75) Inventor: Koji Okada, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/393,929

(22) Filed: Feb. 26, 2009

(30) Foreign Application Priority Data
Jun. 27, 2008 (JP) 2008-169316

(51) Int. Cl. H04N 5/91

(52) U.S. Cl. 386/83; 386/46; 386/E05.001

(57) ABSTRACT

According to one embodiment, a recording/reproducing apparatus includes a reception module for selectively receiving a signal, a signal processing module which subjects a video signal, which is received by the a reception module, to a predetermined signal process, a recording module for recording a signal which is subjected to the signal process by the signal processing module, and a control module for controlling the reception module, the signal processing module and the recording module, wherein the control module includes a determination module for determining, when program information of a recorded program is to be displayed, whether the recorded program meets a predetermined standard, and a switching module for switching a range of date/time for displaying the program information of the recorded program, on the basis of a determination result of the determination module.

### CROSS-REFERENCE TO RELATED APPLICATIONS

This application is based upon and claims the benefit of priority from Japanese Patent Application No. 2008-169316, filed Jun. 27, 2008, the entire contents of which are incorporated herein by reference.

### BACKGROUND

1. Field

The present invention relates generally to a recording/reproducing apparatus and a control method of the recording/reproducing apparatus, and more particularly to a recording/reproducing apparatus which is capable of receiving a digital broadcast signal and a control method of this recording/reproducing apparatus.

2. Description of the Related Art

As is well known, in Japan, not only satellite digital broadcasting, such as BS (broadcasting satellite) digital broadcasting and CS (communication satellite) digital broadcasting, but also ground digital broadcasting has been started.

A recording/reproducing apparatus includes a reception module for selectively receiving a signal by broadcasting or over a network; a signal processing module for subjecting a received signal to signal processing; and a recording module such as a hard disk drive for recording a signal which has been subjected to the signal processing.

Conventionally, for example, there has been proposed a broadcast program recording/reproducing system which accumulates program schedule information which is acquired by broadcasting or over a network, and executes display, selection, reproduction and deletion in accordance with actually recorded programs (see Jpn. Pat. Appln. KOKAI Publication No. 2005-311628).

In the above-described broadcast program recording/reproducing system, the acquired program schedule information is utilized by accumulating an “electronic program table” or metadata from a broadcast station. Programs are separately recorded, and a content table (electronic content guide: ECG) is displayed so as to make the recorded programs discriminable.

In this broadcast program recording/reproducing system, a calendar is first displayed on the ECG display on the screen of a TV set. If a date (the current day or the other day) is selected, the program schedule information relating to the selected date is displayed in accordance with the EPG information. Only recorded programs are displayed on the ECG.

In addition, there has been proposed a recording/reproducing apparatus which displays the program title of the recorded program together with a calendar-format recording list (see Jpn. Pat. Appln. KOKAI Publication No. 2007-12102). In this recording/reproducing apparatus, the cursor is operated by a user, and if a certain date is selected, the program information of the program, which is recorded on the selected date, is displayed as a program-by-program recording list on the same screen.

In the case where the difference in number of recorded programs is very large between dates/times, the display of program information of the selected date is an effective display method. However, if programs, which are recorded on the selected date, are displayed in the state in which the number of recorded programs is small, the recorded programs are dispersedly displayed, and it is difficult for the user to find a program which the user wants to view.

In recent years, in the digital TV broadcast reception apparatus which receives TV broadcast, for example, the following recording method has been proposed. That is, all programs, which are broadcast in a predetermined time period, for instance, in one week, are recorded, and programs, after a predetermined time has passed since the recording thereof, are successively deleted from unnecessary ones, in accordance with the remaining capacity of the hard disk or the setting by the user. Then, finally, all programs, except the program which the user wishes to save, are deleted.

In particular, in the above-described apparatus which records all programs that are broadcast during a predetermined time period and which successively deletes programs after a predetermined time has passed since the recording thereof, the display of, e.g. EPG (“TV & radio program table display”) may be thought as a method of presenting recorded programs.

However, as has been described above, there is a large difference in number of recorded programs before and after the passage of a predetermined time period. Before the passage of the predetermined time period, the TV & radio program table display is an effective method as recorded program display. However, after the passage of the predetermined time period, the number of recorded programs decreases, and the recorded programs are dispersedly indicated on the TV & radio program table display, and thus it becomes difficult to find a program on the TV & radio program table display.

In addition, if the TV & radio program table display is used only for the display before the passage of the predetermined time period, it is necessary for the user to understand whether a predetermined time period has passed since the recording of a program which the user wishes to view, and it is necessary for the user to selectively use one of a plurality of search methods. Hence, the degree of difficulty increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 schematically shows the exemplary external appearance of a recording/reproducing apparatus according to an embodiment of the present invention;

FIG. 2 is a block diagram for describing an example of a signal processing system of exemplary the recording/reproducing apparatus shown in FIG. 1;

FIG. 3 is a view for describing a first example of the TV & radio program table display for displaying recorded programs in exemplary recording/reproducing apparatuses according to first and second embodiments of the present invention;

FIG. 4 is a view for describing an example of monthly calendar display for displaying recorded programs in the exemplary recording/reproducing apparatuses according to the first and second embodiments of the present invention;

FIG. 5 is a view for describing a second example of the TV & radio program table display of displaying recorded programs in the exemplary recording/reproducing apparatus according to the second embodiment of the invention;

FIG. 6 is a view for describing a third example of the TV & radio program table display for displaying recorded programs in the exemplary recording/reproducing apparatus according to the second embodiment of the invention;

FIG. 7 is a flow chart for describing an example of a switching operation of recorded program display in the exemplary recording/reproducing apparatus according to the first embodiment of the invention; and

FIG. 8 is a flow chart for describing an example of a switching operation of recorded program display in the exemplary recording/reproducing apparatus according to the second embodiment of the invention.

### DETAILED DESCRIPTION

Various embodiments according to the invention will be described hereinafter with reference to the accompanying drawings. In general, according to one embodiment of the invention, there is provided a recording/reproducing apparatus comprising: a reception module for selectively receiving a signal; a signal processing module which subjects a video signal, which is received by the reception module, to a predetermined signal process; a recording module for recording a signal which is subjected to the signal process by the signal processing module; and a control module for controlling the reception module, the signal processing module and the recording module, wherein the control module includes: a determination module for determining, when program information of a recorded program is to be displayed, whether the recorded program meets a predetermined standard; and a switching module for switching a range of date/time for displaying the program information of the recorded program, on the basis of a determination result of the determination module.

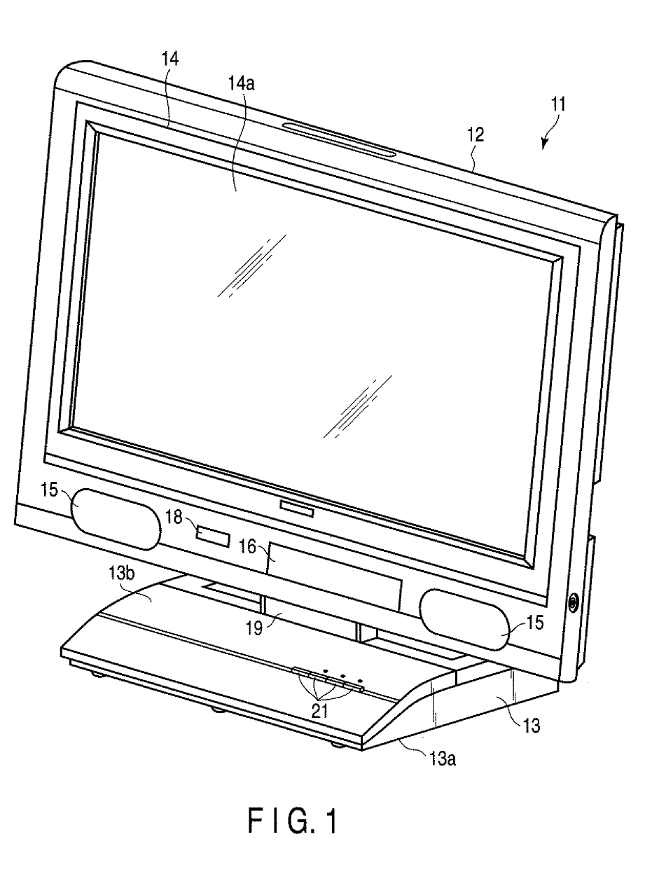

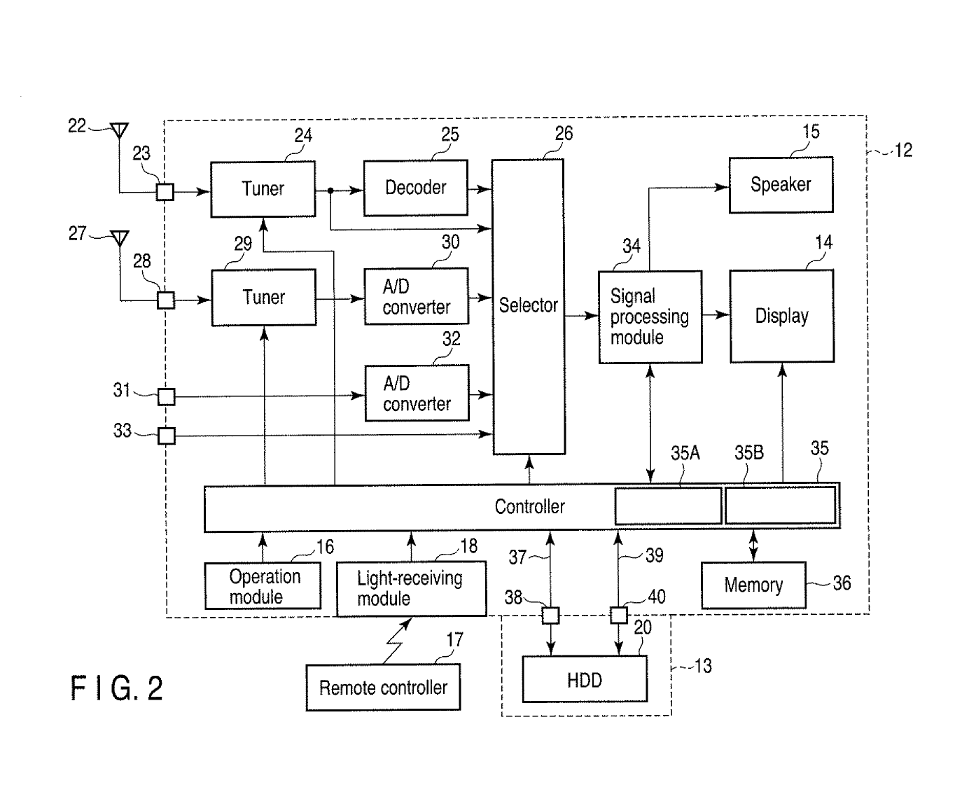

A recording/reproducing apparatus according to a first embodiment of the present invention and a control method of the recording/reproducing apparatus will now be described with reference to the accompanying drawings. As is shown in FIG. 1, the recording/reproducing apparatus according to the embodiment is a TV receiver apparatus including tuners 24 and 29 (shown in FIG. 2) and a display 14.

The embodiment of the invention is described in detail with reference to the drawings. As shown in FIG. 1, a recording/reproducing apparatus 11 mainly comprises a cabinet 12 with small thickness, which is an apparatus main body and is formed in a substantially rectangular shape, and a stand 13 which supports the cabinet 12 upright.

A display screen 14a of a display 14, which is formed of, e.g. a flat liquid crystal display panel, is exposed on the front surface of the cabinet 12. In addition, a pair of speakers 15, an operation module 16 and a light-receiving module 18, which receives operation information that is sent from a remote controller (not shown in FIG. 1) to be described later, are disposed on the front surface of the cabinet 12.

The stand 13 is formed in a thin box shape. The stand 13 is configured such that one flat bottom plate 13a thereof is placed on a given base (not shown) which is disposed horizontal. The stand 13 supports the cabinet 12 upright, in such a manner that a support member 19 thereof, which projects upward from a substantially central part of a top plate, which is opposite to the surface of the stand 13 placed on the base, is coupled to a back surface of the cabinet 12.

The stand 13 is configured to be able to accommodate therein an HDD module (not shown in FIG. 1) that is to be described later. The top plate 13b of the stand 13 has a portion projecting to the front side from the cabinet 12, where a plurality (four in FIG. 1) of operation elements 21, which can be pressed and operated for controlling the state of the HDD module 20, such as a recording state, a reproduction state and a stop state, are disposed.

FIG. 2 schematically shows a signal processing system of the recording/reproducing apparatus 11. Various circuit blocks, which constitute the signal processing system, are mainly disposed within the cabinet 12 near the back surface thereof, that is, near the back side of the display screen 14a of the display 14.

A digital TV broadcast signal, which is received by an antenna 22 for digital TV broadcast reception, is supplied to a tuner module 24 via an input terminal 23. The tuner module 24 selects a signal of a desired channel from input digital TV broadcast signals, and demodulates the selected signal.

A signal, which is output from the tuner module 24, is supplied to a decoder module 25, and subjected to, e.g. an MPEG (moving picture experts group) 2 decoding process, and the resultant processed signal is delivered to a selector 26.

The output from the tuner section 24 is also supplied directly to the selector 26. Video/audio information may be separated from the signal that is supplied to the selector 26, and the video/audio information may be recorded in the HDD module 20 via a controller 35.

Further, an analog TV broadcast signal, which is received by the antenna 27 for analog TV broadcast reception, is supplied to a tuner module 29 via an input terminal 28. The tuner section 29 selects a signal of a desired channel from input analog TV broadcast signals, and demodulates the selected signal. A signal, which is output from the tuner module 29, is converted to a digital signal by an A/D (analog/digital) conversion module 30, and the digital signal is output to the selector 26.

Analog video and audio signals, which are supplied to an input terminal 31 for analog signals, are supplied to an analog/digital conversion module 32 and converted to digital signals, and the digital signals are output to the selector 26. Further, digital video and audio signals, which are supplied to an input terminal 33 for digital signals, are supplied directly to the selector 26.

In the case where the A/D converted signal is to be recorded in the HDD module 20, the A/D converted signal is subjected to a compression process of a predetermined format, e.g. MPEG (moving picture experts group) 2 method, by an encoder which is provided in the selector 26, and the resultant processed signal is recorded in the HDD module 20.

The selector 26 selects one of the four kinds of input digital video/audio signals, and supplies the selected signal to a signal processing module 34. The signal processing module 34 executes a predetermined signal process on the input digital video signal, and causes the display 14 to display the processed video signal.

A flat-panel display, such as a liquid crystal display or a plasma display, is adopted as the display 14. In addition, the signal processing module 34 executes a predetermined signal process on the input digital audio signal, and converts the digital audio signal to an analog audio signal. The signal processing module 34 outputs the analog audio signal to the speakers 15, thus reproducing audio.

In this recording/reproducing apparatus 11, the controller 35 executes an overall control of the various operations including the above-described various signal reception operations. The controller 35 is a microprocessor which incorporates a CPU (central processing module). The controller 35 receives operation information from the operation module 16, or receives via the light-receiving module 18 operation information that is sent from the remote controller 17, thereby controlling the respective modules so as to reflect the operation contents.

The controller 35 uses a memory module 36 during the control operation. The memory module 36 mainly comprises a ROM (read-only memory) which stores control programs that are executed by the CPU of the controller 35, a RAM (random access memory) for providing a working area for the CPU, and a nonvolatile memory which stores various setting information and control information.

The controller 35 is connected to the HDD module 20 which is accommodated in the stand 13. In this case, a line 37, which supplies power and control signals to the HDD module 20 from the controller 35, connects the controller 35 and HDD module 20 via a connection module 38.

A line 39, which executes transmission/reception of digital video and audio signals between the controller 35 and HDD module 20, connects the controller 35 and HDD module 20 via an i.Link connection module 40. In short, the transmission of digital video and audio signals between the controller 35 and HDD module 20 is executed by i.Link, separately from the transmission of power and control signals.

The recording/reproducing apparatus 11 can record the digital video and audio signals, which are selected by the selector 26, in the HDD module 20, and can reproduce the digital video and audio signals, which are recorded in the HDD module 20, so that the digital video and audio signals may be viewed/listened to.

In the recording/reproducing apparatus 11, in the case where an operation for displaying the digital broadcast program, which is recorded in the HDD module 20, is executed by the operation module 16 or the remote controller 17, the controller 35 controls the signal processing module 34 and supplies to the display 14 a display signal for displaying a recorded program display screen.

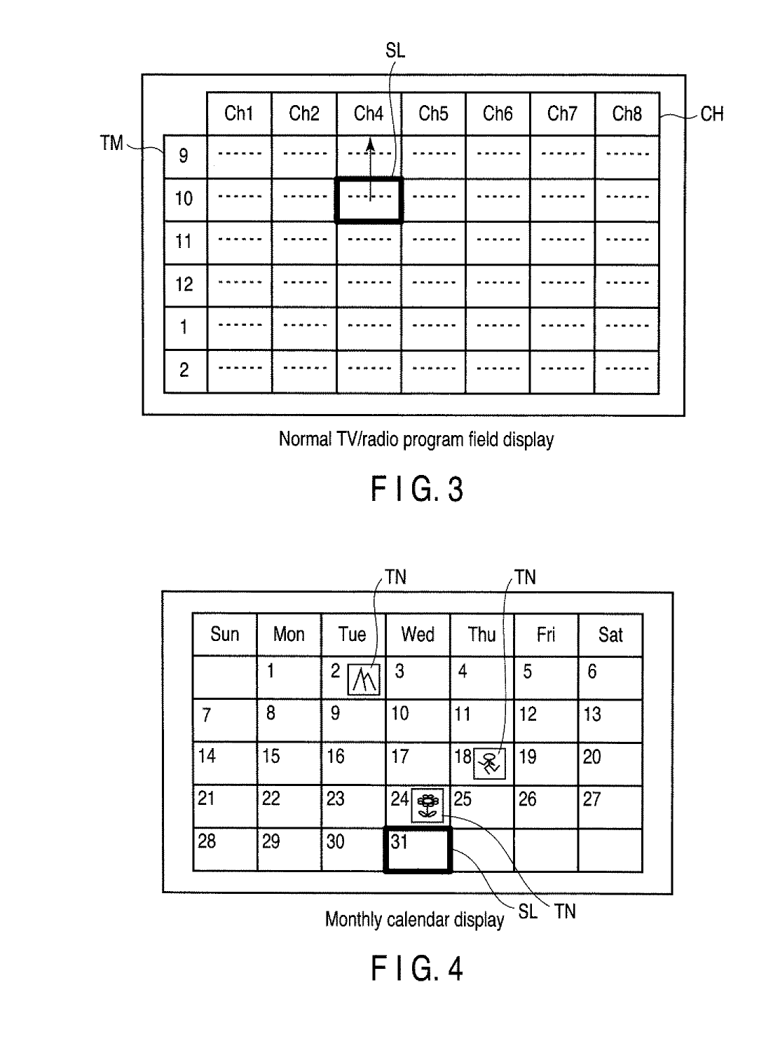

In the case of displaying a recorded program in units of a time including a predetermined time, a time axis is set in the vertical direction of the screen, for example, as shown in FIG. 3. Broadcast time fields TM are arranged in the time axis direction, and channel fields CN are set in a direction substantially perpendicular to the time axis direction. Thus, recorded program information is displayed in the field of the associated channel and the associated broadcast time.

The recorded program display (hereinafter referred to as “TV/radio program field display”) in units of a time including a predetermined time is particularly effective, for example, in the case of displaying recorded programs in the period during which all broadcast programs are programmed to be recorded.

The program information to be displayed may be based on EPS information included in the digital broadcast signal, or may be based on program information that is received via the network, independently from the broadcast signal.

At this time, for example, the user operates the cursor key (not shown) of the remote controller 17, and moves the position of a selection frame SL, as shown in FIG. 3, thereby scrolling the display screen and being able to search for a recorded program.

When the user moves the selection frame SL, the program list display screen may be scrolled such that the selection frame SL is displayed at the center of the screen, or that the selection frame SL is moved within the screen.

In addition, for example, the user can display more detailed information of the recorded program by moving the selection frame SL to the field of the desired program information and pressing the decision button on the remote controller 17. Furthermore, the user can perform an operation to selectively delete a program recorded in the HDD module 20, from the displayed program information.

The controller 35 includes a determination module which determines whether the recorded program meets a predetermined standard when the information of the recorded program is to be displayed, and a switching module which switches the display of the recorded program information between the recorded program information display in units of a time including a predetermined time and the recorded program display in units of a day including a predetermined day.

The controller 35 of the recording/reproducing apparatus 11 according to the present embodiment includes a first determination module 35A which acquires date information of the field at which the selection frame SL is positioned and determines whether a predetermined time period has passed since the date of the acquired date information up to the present date, and a first switching module 35B which switches the recorded program display to, for example, recorded program display in units of a day including a predetermined day, as shown in FIG. 4 (hereinafter referred to as “monthly calendar display”), in a case where the first determination module 35A determines that the date of the field, where the selection frame SL is positioned, is a date which is a predetermined time period before.

In the case where the recorded program display is the monthly calendar display, as shown in FIG. 4, if the first determination module 35A determines that the date of the field, where the selection frame SL is positioned, is a date which is not a predetermined time before, the first switching module 35B switches the recorded program display to, for example, a TV/radio program field display as shown in FIG. 3.

When the TV/radio program field display is switched to the monthly calendar display, the first switching module 35B controls the signal processing module 34 so that thumbnails TN, which have been displayed immediately before the switching of display, are preferentially displayed. For example, if the thumbnail TN of a program, which is recorded every week, is present in the field where the selection frame SL is positioned, the first switching module 35B controls the signal processing module 34 so that this thumbnail TN is preferentially displayed on the monthly calendar display after switching.

As has been described above, by preferentially displaying the thumbnail TN of the program, which is recorded every week by the user, at the channel of the field where the selection frame SL has been positioned, the user can easily find the desired program when the display is switched to the monthly calendar display. In the meantime, the thumbnail TN, which is preferentially displayed, may not be the thumbnail TN that has been displayed immediately before, but may be the thumbnail TN of the program which is often recorded by the user.

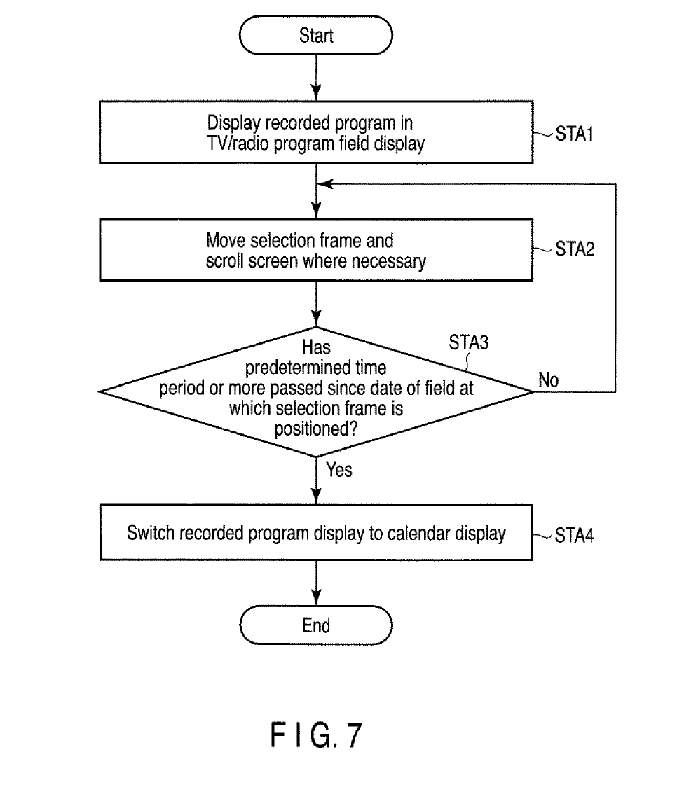

Next, a description is given of the switching operation of the recorded program display screen in the recording/reproducing apparatus according to the present embodiment. If instruction information for displaying recorded programs is supplied to the controller 35 of the recording/reproducing apparatus 11 by the operation module 16 or remote controller 17, the controller 35, for example, displays the recorded programs of the present date by the TV/radio program field display as shown in FIG. 3 (block STA1 in FIG. 7).

At this time, if the user operates, for example, the cursor key of the remote controller 17 and the instruction information for moving the selection frame SL is supplied to the controller 35, the controller 35 controls the signal processing module 34 according to the supplied instruction information and moves the position of the selection frame SL that is displayed on the display screen 14a, and scrolls, where necessary, the recorded program information that is displayed on the display screen 14a (block STA2).

The first determination module 35A of the controller 35 determines whether a predetermined time period has passed since the date of the field, where the selection frame SL is positioned, up to the present date (block STA3). At this time, if the first determination module 35A determines that the date of the field, where the selection frame SL is positioned, is a date which is a predetermined time period before, the first switching module 35B controls the signal processing module 34 and switches the recorded program display to the monthly calendar display as shown in FIG. 4 (block STA4).

While the recorded program display is being the monthly calendar display as shown in FIG. 4, if the first determination module 35A determines that the date of the field at which the selection frame SL is positioned is a date which is not a predetermined time period before the present date, the first switching module 35B controls the signal processing module 34 and switches the recorded program display to the TV/radio program field display as shown in FIG. 3.

Similarly, in the recorded program display switching operation in the above-described recording/reproducing apparatus 11, the display can be switched from the monthly calendar display to the TV/radio program field display. In this case, for example, while the monthly calendar display as shown in FIG. 4 is being displayed, the first determination module 35A determines whether a predetermined time period has passed since the date of the field at which the selection frame SL is positioned. If the first determination module 35A determines that the predetermined time period has not passed, the first switching module 35B controls the signal processing module 34 and switches the recorded program display from the monthly calendar display to the TV/radio program field display.

As has been described above, by switching the display screen of recorded programs with reference to the elapsed time from the present date or a predetermined date, it becomes possible to present a consistent operation method to the user, and to improve the convenience for the user.

In particular, in the recording/reproducing apparatus which is so set as to record all programs that are broadcast during a predetermined time period, that is, in the recording/reproducing apparatus in which there is a difference in number of recorded programs between the dates of recording before and after the passage of a predetermined time period, a consistent operation method can be presented to the user by automatically changing, on the apparatus side, the optimal recorded program presentation method with reference to the date/time. Thereby, the convenience for the user can more effectively be improved.

In short, according to the recording/reproducing apparatus of the present embodiment and the control method of the recording/reproducing apparatus, the optimal recorded program presentation method can automatically be changed with reference to a predetermined standard, and the consistent operation method is presented. Thereby, the recording/reproducing apparatus and the control method of the recording/reproducing apparatus, which can improve the convenience for the user, can be provided.

Next, a recording/reproducing apparatus according to a second embodiment of the invention and a control method of the recording/reproducing apparatus are described with reference to the accompanying drawings. In the description below, the structural parts common to those of the recording/reproducing apparatus and the control method thereof according to the first embodiment are denoted by like reference numerals, and a description thereof is omitted.

Like the above-described recording/reproducing apparatus of the first embodiment, the recording/reproducing apparatus according to the present embodiment has its operations totally controlled by the controller 35. The controller 35 includes a second determination module (not shown) which counts the number of programs which are recorded on the date of the field at which the selection frame SL is disposed, and determines whether the number of recorded programs is a predetermined number A1 or more, and a second switching module (not shown) which switches the recorded program display from the TV/radio program field display, as shown in FIG. 3, to the monthly calendar display, for example, as shown in FIG. 4, in the case where the second determination module determines that the number of recorded programs is not the predetermined number A1 or more.

In the case where recorded programs are displayed over a plurality of dates, the second determination module may be configured to count the number of programs which are recorded during a predetermined time period that is displayed, and to determine whether the number of recorded programs is the predetermined number A1 or more.

In the case where the recorded program display is the monthly calendar display as shown in FIG. 4, if the second determination module determines that the number of recorded programs on the date of the field at which the selection frame SL is positioned is the predetermined number A1 or more, the second switching module switches the recorded program display to, for example, the TV/radio program field display, as shown in FIG. 3.

Further, in the recording/reproducing apparatus 11 according to the present embodiment, the controller 35 includes a third determination module (not shown) which determines there is a blank field in which no program is recorded on the date of the field where the selection frame SL is positioned, and a fourth determination module (not shown) which counts the number of programs that are recorded during a predetermined time period including the date of the field at which the selection frame SL is positioned or the time of the field at which the selection frame SL is positioned, and determines whether the number of recorded programs is a predetermined number A2 (A2>A1).

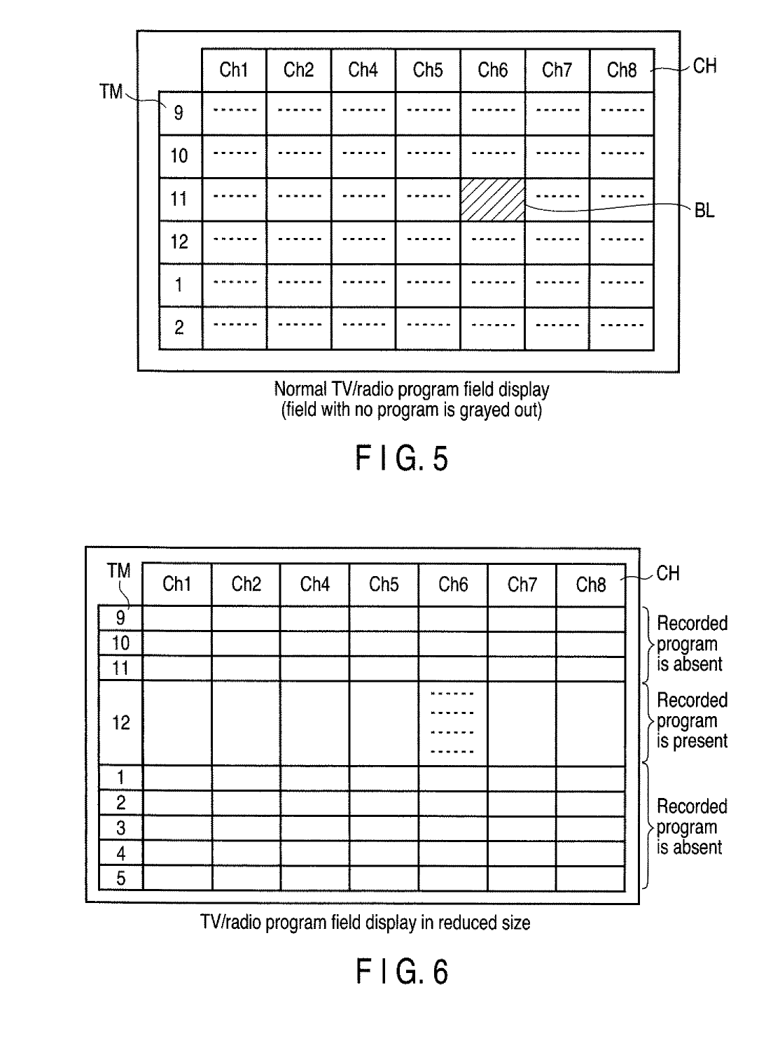

In the case where the third determination module determines that there is a blank field in which no program is recorded, the second switching module controls the signal processing module 34 in such a manner that a field BL with no recorded program in the TV/radio program field display, as shown in FIG. 5, is displayed in a color, e.g. gray, which is different from the color of the field with a recorded program, or the field BL with no recorded program is displayed in hatching.

In the case where the fourth determination module determines that the number of recorded programs is the predetermined number A2 or less and the second determination module determines that the number of recorded programs is not the predetermined number A1 or less, the second switching module controls the signal processing module 34 in such a manner that the time scale of the time in which there is no recorded program is displayed to be smaller than the time scale of the time in which there is a recorded program.

Specifically, as shown in FIG. 6, the second switching module controls the signal processing module 34 so that the width in the time axis direction of the row of the TV/radio recorded program field display, in which there is no recorded program, is displayed to be smaller than the width in the time axis direction of the row in which there is a recorded program.

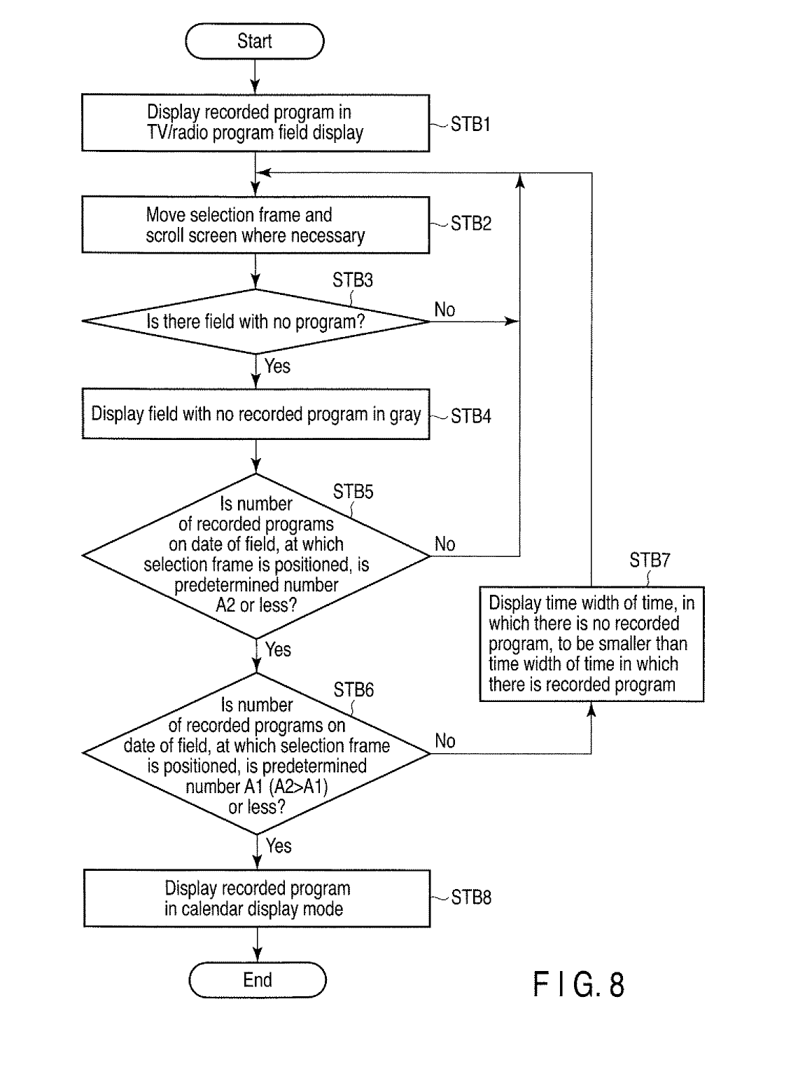

As illustrated in FIG. 8, in the switching operation of the recorded program display screen in the recording/reproducing apparatus 11 according to the present embodiment, if instruction information for displaying the recorded program is supplied to the controller 35 of the recording/reproducing apparatus 11 by the operation module 16 or remote controller 17, the controller 35 displays, for example, the recorded programs of the current date by the display mode of the TV/radio program field display, as shown in FIG. 3 (block STB1).

At this time, if the user operates, for example, the cursor key of the remote controller 17 to supply instruction information for moving the selection frame SL, the controller 35 controls the signal processing module 34 according to the supplied instruction information, thereby moving the position of the selection frame SL that is displayed on the display screen 14a, and scrolling, where necessary, the recorded program information that is displayed on the display screen 14a (block STB2).

Subsequently, the third determination module determines whether there is a blank field BL in which no program is recorded on the date of the field where the selection frame SL is positioned (block STB3). If the third determination module determines that there is a blank field BL in which no program is recorded, the second switching module controls the signal processing module 34 so that a field BL with no recorded program is displayed in, e.g. gray, in a manner different from the display of the other fields, as shown in FIG. 5 (block STB4).

Next, the fourth determination module determines whether the number of recorded programs on the date of the field at which the selection frame SL is positioned is a predetermined number A2 or less (block STS5). If the fourth determination module determines that the number of recorded programs is the predetermined number A2 or less, the second determination module determines whether the number of recorded programs on the date of the field at which the selection frame SL is positioned is a predetermined number A1 or less (block STB6).

If the second determination module determines that the number of recorded programs is not the predetermined number A1 or less, the second switching module controls the signal processing module 34 so that the width in the time axis direction of the row, in which there is no recorded program, is displayed to be smaller than the width in the time axis direction of the row in which there is a recorded program (block STB7). In the case shown in FIG. 6, since recorded programs are present in the row of 12 o'clock, the TV/radio program field display is executed such that the width in the time axis direction of each of the rows other than the row of 12 o'clock is smaller than the width in the time axis direction of the row of 12 o'clock.

If the second determination module determines that the number of recorded programs is the predetermined number A1 or less, the second switching module 34 controls the signal processing module 34 and switches the recorded program display to the monthly calendar display as shown in FIG. 4 (block STB8).

As has been described above, by switching the display screen of recorded programs with reference to the number of recorded programs that are recorded on a predetermined date or during the time period including a predetermined time, it becomes possible to present a consistent operation method to the user, and to improve the convenience for the user.

Specifically, according to the present embodiment, there can be provided a recording/reproducing apparatus and a control method of the recording/reproducing apparatus, wherein the optimal recorded program presentation method can automatically be changed with reference to a predetermined standard, and the consistent operation method is presented, thereby improving the convenience for the user.

The present invention is not limited directly to the above-described embodiments. In practice, the structural elements can be modified and embodied without departing from the spirit of the invention. For example, each of the recording/reproducing apparatuses 11 according to the first embodiment and second embodiment includes the display 14 and speakers 15. Alternatively, the display 14 and speakers 15 may be provided separately from the recording/reproducing apparatus 11 and may be connected to the outside of the recording/reproducing apparatus 11. In this case, too, the same advantageous effects as with the recording/reproducing apparatus 11 and the control method of the recording/reproducing apparatus 11 according to each of the first and second embodiments can be obtained.

In the recording/reproducing apparatus 11 according to the first embodiment, like the recording/reproducing apparatus 11 according to the second embodiment, the first switching module 35B may switch the display so as to distinguish the field in which a recorded program is present and the field in which a recorded program is absent, for example, in such a manner that a field BL with no recorded program in the TV/radio program field display is displayed in a color which is different from the color of the field with a recorded program.

In addition, in the recording/reproducing apparatus 11 according to the first embodiment, like the recording/reproducing apparatus 11 according to the second embodiment, the first switching module 35B may control the signal processing module 34 so as to switch the normal TV/radio program field display to the TV/radio program field display in which the width in the time axis direction of the row, in which there is no recorded program, is displayed to be smaller than the width in the time axis direction of the row in which there is a recorded program, in accordance with the elapsed time from the date of the field, where the selection frame SL is positioned, to the present date, and so as to switch the TV/radio program field display to the monthly calendar display in the case where the elapsed time becomes longer.

In the recording/reproducing apparatuses according to the first embodiment and second embodiment, the TV/radio program field display and the monthly calendar display are switched on the basis of the standard, such as the elapsed time up to the present date or the number of recorded programs on a predetermined date. Alternatively, TV/radio program field display, weekly calendar display and monthly calendar display may be switched stepwise.

By switching the recorded program display in a stepwise manner, as described above, in accordance with the elapsed time from the date of the field, at which the selection frame SL is positioned, up to the present date, it becomes possible to provide a recording/reproducing apparatus and a control method of the recording/reproducing apparatus, which can more effectively improve the convenience for the user.

Various inventions can be made by properly combining the structural elements disclosed in the embodiments. For example, some structural elements may be omitted from all the structural elements disclosed in the embodiments. Furthermore, structural elements in different embodiments may properly be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules or components on one or more computers, such as servers. While the various modules are illustrated separately, they may share some or all of the same underlying logic or code.

What is claimed is:

1. A recording/reproducing apparatus comprising:
a reception module for selectively receiving a signal;
a signal processing module which subjects a video signal, which is received by the reception module, to a predetermined signal process;
a recording module for recording a signal which is subjected to the signal process by the signal processing module; and
a control module for controlling the reception module, the signal processing module and the recording module,
wherein the control module includes:
a determination module for determining, when program information of a recorded program is to be displayed, whether the recorded program meets a predetermined standard; and
a switching module for switching a range of date/time for displaying the program information of the recorded program, on the basis of a determination result of the determination module.

2. The recording/reproducing apparatus of claim 1, wherein the determination module includes first determination module for determining whether a predetermined time period has passed since the recording of the recorded program up to a present time, and
the switching module includes a first switching module for switching, in a case where the predetermined time period has passed since the recording of the recorded program, display of the program information from display in units of a time including a predetermined time to display in units of a day including a predetermined day, and switching, in a case where the predetermined time period has not yet passed since the recording of the recorded program, the display of the program information to the display in module of a time including a predetermined time.

3. The recording/reproducing apparatus of claim 1 or 2, wherein the determination module includes a second determination module for determining whether a number of programs, which are recorded during a predetermined time period, is a first number or more, and
the switching module includes a second switching module for switching, in a case where the number of programs that are recorded is the first number or more, display of the program information from display in units of a day including a predetermined day to display in units of a time including a predetermined time, and switching, in a case where the number of programs that are recorded is not the first number or more, the display of the program information from the display in units of a time including a predetermined time to the display in units of a day including a predetermined day.

4. The recording/reproducing apparatus of claim 3, wherein the determination module includes a third determination module for determining whether the number of programs, which are recorded during the predetermined time period, is a second number or more, and
the second switching module includes a module for displaying, in a case where the number of programs that are recorded during the predetermined time period including the predetermined time is not less than the first number and is less than the second number when the program information is displayed in units of a time including the predetermined time, a time scale of a time in which there is no recorded program to be smaller than a time scale of a time in which there is a recorded program.

5. The recording/reproducing apparatus of any one of claim 1 or 2, wherein the switching module includes a module for preferentially displaying a thumbnail of a recorded program that has been displayed immediately before the switching of display, when the display in units of a time including the predetermined time is switched to the display in units of a day including the predetermined day.

6. The recording/reproducing apparatus according to any one of claim 1 or 2, further comprising a video display which displays the video signal that has been subjected to a predetermined signal process in the signal processing module.

7. A control method of a recording/reproducing apparatus including a reception module for selectively receiving a signal, a signal processing module which subjects a video signal, which is received by the reception module, to a predetermined signal process, a recording module for recording a signal which is subjected to the signal process by the signal processing module, and a control module for controlling the reception module, the signal processing module and the recording module, the control method comprising:
a determination step of for determining, when program information of a recorded program is to be displayed, whether the recorded program meets a predetermined standard; and
a switching step of switching a range of date/time for displaying the program information of the recorded program, on the basis of a determination result in the determination step.

8. The control method of the recording/reproducing apparatus of claim 7, wherein the determination step includes a first determination step of determining whether a predetermined time period has passed since the recording of the recorded program up to a present time, and
the switching step includes a first switching step of switching, in a case where the predetermined time period has passed since the recording of the recorded program, display of the program information from display in units of a time including a predetermined time to display in units of a day including a predetermined day, and switching, in a case where the predetermined time period has not yet passed since the recording of the recorded program, the display of the program information to the display in units of a time including a predetermined time.

9. The control method of the recording/reproducing apparatus of claim 7 or 8, wherein the determination step includes a second determination step of determining whether a number of programs, which are recorded during a predetermined time period, is a first number or more, and
the switching step includes a second switching step of switching, in a case where the number of programs that are recorded is the first number or more, display of the program information from display in units of a day including a predetermined day to display in units of a time including a predetermined time, and switching, in a case where the number of programs that are recorded is not the first number or more, the display of the program information from the display in units of a time including a predetermined time to the display in units of a day including a predetermined day.

10. The control method of the recording/reproducing apparatus according to claim 9, wherein the determination step includes a third determination step of determining whether the number of programs, which are recorded during the predetermined time period, is a second number or more, and
the switching step includes a step of displaying, in a case where the number of programs that are recorded during the predetermined time period including the predetermined time is not less than the first number and is less than the second number when the program information is displayed in units of a time including the predetermined time, a time scale of a time in which there is no recorded program to be smaller than a time scale of a time in which there is a recorded program.
